(19) United States
(12) Patent Application Publication
(10) Pub. No.: US 2016/0140605 A1
(43) Pub. Date: May 19, 2016

(54) Generating Audience Metrics Including Affinity Scores Relative to An Audience

(71) Applicant: Facebook, Inc., Menlo Park, CA (US)

(72) Inventors: Michael Lee Develin, San Franciso, CA (US); Guven Burc Arpat, Los Altos, CA (US); Srikant Ramakrishna Ayyar, Menlo Park, CA (US)

(21) Appl. No.: 14/542,411

(22) Filed: Nov. 14, 2014

(51) Int. Cl. G06Q 30/02; H04L 29/08

(52) U.S. Cl. CPC G06Q 30/0246; H04L 67/22

(57) ABSTRACT

A social networking system receives a selection of user characteristics defining a benchmark audience and a target audience, and generates audience metrics that compare the audiences across a set of user characteristics. These user characteristics include demographics, interests, purchasing activity, and actions on the social networking system. The audience metrics are provided to an advertiser who may select additional user characteristics to refine the benchmark or target audiences. The audience metrics may include an affinity score that compares the audience metrics for a particular type of interaction, and may normalize the frequency of interactions relative to interactions of the audience as a whole. Advertisers may use the defined audiences to establish targeting criteria for an advertisement, and may use existing targeting criteria to seed the selection of an audience.

### BACKGROUND

This invention relates generally to identifying characteristics of advertising audiences, and in particular to measuring characteristics of audiences relative to a benchmark.

Advertisers generally advertise on online systems by specifying an advertisement, a bid amount, and targeting criteria for the advertisement. The targeting criteria may specify various user characteristics about users to be targeted with the advertisement, such as demographics information or interaction of a user within a social networking system. However, advertisers typically identify their own targeting criteria to provide to the social networking system. Thus, advertisers select targeting criteria without particular insights into additional user characteristics of the audience that will receive the advertisement. For example, advertisers cannot determine how the targeted users may differ from other users of the social networking system. In addition, an advertiser cannot determine differences between users falling within the targeting criteria, and users that meet the targeting criteria and interact with an advertiser's page on the social networking system. This prevents advertisers from more deeply understanding their desired audiences, and may prevent advertisers from effectively advertising to these audiences, for example to generate advertising creative that will appeal to other interests of the advertiser's audience.

### SUMMARY

A social networking system generates audience information for advertisers to obtain information about users being targeted by advertisements. Users in the social networking system are associated with a variety of different types of user characteristics, which may describe many different attributes of a user known to the social networking system. Some example types of user characteristics include demographic information, purchasing behavior, and social networking actions. Thus, one example user may be known to be a 28-year old male that is in-market for a vehicle, and has interacted with (“liked”) several pages on the social networking system. Advertisers may identify user characteristics to define targeting criteria and an audience of users meeting those user characteristics. The social networking system permits advertisers to analyze how a target audience differs from a benchmark with regard to other user characteristics. A user selecting user characteristics of “male,” 18-35,” and “likes soccer” receives an analysis of the audience of users defined by those characteristics as compared to other users of the social networking system. This analysis may reveal, for example, that relative to the benchmark, this audience tends to be better-educated, is more likely to live in a specific geographic area, and is more likely to interact with certain other interests on the social networking system. This provides the advertiser additional information about how the target audience differs from the benchmark in the social networking system. The benchmark may be selected by the user and may vary according to implementation, such as all users of the social networking system or users within a particular country. In other examples, the benchmark includes further user characteristics. The target audience may be a subset of the benchmark (i.e., all members of the target audience are also members of the benchmark), or the target audience may be defined by separate user characteristics, and may have no overlap in users with the benchmark. In one example, the target audience is a subset of the benchmark that includes users that interacted with (e.g., liked) an advertiser's page on the social networking system.

In one embodiment, the social networking system provides an interface for an advertiser to explore differences in user characteristics between a benchmark and target audience. The social networking system identifies a set of user characteristics defining a benchmark and a set of user characteristics defining the target audience. The social networking system identifies a set of benchmark users matching the user characteristics of the benchmark and a set of target users matching the user characteristics for the target audience. For these sets of users, the social networking system generates an audience metric for a set of user characteristics. The audience metric indicates, for example, for each user characteristic, the difference in frequency of incidence of the user characteristic between the benchmark users and target users. The interface provides these audience metrics to the advertiser to view the audience metrics. The advertiser may interact with the interface to select and add user characteristics to the benchmark or target audience. For example a user may click on a displayed user characteristic associated with an audience metric to select that user characteristic and add the characteristic to the user characteristics defining the target audience. The target users and audience metrics are updated with the modified target audience. This permits a user to easily explore target audiences and view audience metrics for user characteristics that differ from the user characteristics that define the benchmark and the target audience.

The audience metric for certain user characteristics may be an affinity score for the user characteristic. The affinity score indicates a ratio of the change in likelihood between the benchmark and target audiences that the user is associated with the user characteristic. These affinity scores may be calculated, for example, for page likes, interests, and other interactions on the social networking system. For example, the affinity score may reveal that target audience users are 5.8 times more likely to like a specific page in the social networking system relative to benchmark users. The affinity score may also be adjusted for the relative frequencies that the target audience and the benchmark are associated with other user characteristics. Thus, prevalence of a page like for a target audience that very frequently interacts with objects on the social networking system is weighted with respect to this high frequency of interaction in general for that target audience. In addition to the affinity score, the social networking system also determines a relevancy score for certain user characteristics in one embodiment. The relevancy score for a user characteristic reflects the affinity of a group adjusted by the size of the group of users in the target audience that have the user characteristic. Thus, a high-affinity group that has very few users in the target audience may be less relevant than a medium-affinity group that has many users in the target audience. The social networking system uses the relevancy score to sort and display the affinity scores and related user characteristics to the user.

The social networking system may also use the audience metrics to assist a user in a purchase flow of advertisements for display in the social networking system. From an advertising purchase interface, the advertiser may select targeting criteria for the advertisement. The targeting criteria for the advertisement are used to determine audience metrics and display audience metrics, such as affinity scores, for a target audience defined by the targeting criteria. In addition, the social networking system provides an interface for the advertiser to explore a target audience and, after identifying a desired target audience, import the user characteristics of the target audience as targeting criteria for the advertisement.

### BRIEF DESCRIPTION OF THE DRAWINGS

FIG. 1 is a high level block diagram of a system environment for a social networking system.

FIG. 2 is an example block diagram of an architecture of the social networking system 140.

FIG. 3 shows an interface for selecting audiences provided by the audience analytics module.

FIGS. 4A-4C show example user interfaces for viewing audience metrics.

FIGS. 5A-5F illustrate an example interface for viewing audience metrics of a target audience and a benchmark audience.

FIG. 6 illustrates a display of audience metrics including affinity scores according to one embodiment.

FIG. 7 shows an example method for generating audience metrics and displaying the audience metrics to a user.

FIG. 8 shows an example interface for a user to generate an advertising request.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

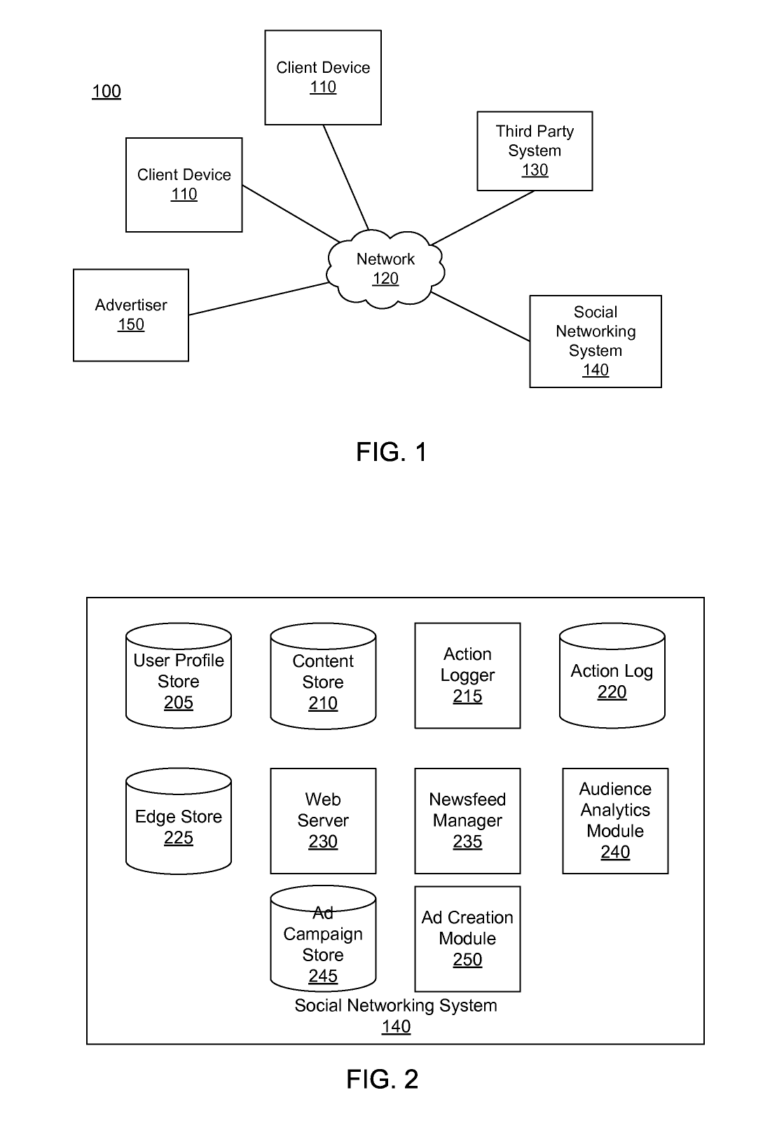

FIG. 1 is a high level block diagram of a system environment 100 for a social networking system 140. The system environment 100 shown by FIG. 1 comprises one or more client devices 110, a network 120, one or more third-party systems 130, the social networking system 140, and advertiser 150. In alternative configurations, different and/or additional components may be included in the system environment 100. The embodiments described herein can be adapted to online systems that are not social networking systems.

The social networking system 140 provides audience analysis and demographics information to advertisers 150. The social networking system 140 identifies a benchmark group and a target group of users (or one or both groups may be specified by the advertiser), and generates audience metrics to describe how the benchmark and target groups differ across several user characteristics. The audience metrics indicate, for example, that the target group is composed of 15% more males than the benchmark group, 10% more users in the 25-35 age group, 4% more users in Dayton, Ohio, and so forth. The advertisers 150 may specify the benchmark and target groups in order to better understand the audiences that the advertisers select for advertising. The advertisers 150 may use the audience metrics to determine information about users that show an interest in the advertisers 150, and otherwise explore information about an audience. In addition, advertisers may navigate an interface displaying audience metrics and add the user characteristics of the target group to targeting criteria of an advertisement.

The user characteristics analyzed by the social networking system 150 include a wide variety of types of information used by the social networking system. As further described below, the user characteristics may generally include demographics, purchasing information, and social networking actions. Example demographics information includes age, sex, lifestyle, relationship status, education level, profession, location, and economic measures (e.g., income or wealth). Example purchasing information includes particular products that a user is “in-market” to purchase, recent purchases, and interactions with advertisements. The purchasing information may include product-level attributes, such as price, color, type, category, and other details about specific products. As an example use case, such purchasing information may be used to generate an audience who purchased or showed an interest in a product, such as an audience of users that purchased an iPhone, a Playstation 4, and a BMW. Social networking actions may describe interactions of a user on the social networking system, such as the user's interactions with a page or event of the advertiser and other objects in the social networking system. These user characteristics are further described below.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the social networking system 140, such as advertisements, content, or information about an application provided by the third party website 130.

The advertiser 150 provides advertisements to social networking system 140 for display to users at client devices 110. The advertisements provided by the advertiser 150 are discussed in further detail below, particularly with respect to ad campaign store 245. The advertiser 150 also includes a computing device for interacting with the social networking system 140. The computing device of the advertiser 150 receives audience information from the social networking system 140 and displays the audience information. The computing device may also receive a selection of user characteristics to modify the displayed audience information and transmit the selected user characteristics to the social networking system 140.

FIG. 2 is an example block diagram of an architecture of the social networking system 140. The social networking system 140 shown in FIG. 2 includes a user profile store 205, a content store 210, an action logger 215, an action log 220, an edge store 225, web server 230, newsfeed manager 235, audience analytics module 240, ad campaign store 245, and ad creation module 250. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding user of the social networking system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the social networking system 140 displayed in an image. A user profile in the user profile store 205 may also maintain references to actions by the corresponding user performed on content items in the content store 210 and stored in the action log 220.

In addition to user-provided information, the social networking system 140 may also receive information from third parties describing users of the social networking system. For example, the social networking system 140 may receive information from a data aggregator that collects demographics, purchasing, and advertising information about users. This information may be stored by the social networking system 140 and used in analyzing groups of customers as an audience for an advertiser. The purchasing information may indicate, for example, that a user is considered in-market for a particular item, or that a user has recently purchased specific items. The information received from data aggregators may be partially anonymized from the data aggregator, and prevent specific identification of social networking system users. For example, a data aggregator may describe characteristics of a group of individuals, rather than specific individuals within the group.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups, or applications. In some embodiments, objects are received from third-party applications or third-party applications separate from the social networking system 140. In one embodiment, objects in the content store 210 represent single pieces of content or content “items.” Hence, users of the social networking system 140 are encouraged to communicate with each other by posting text and content items of various types of media through various communication channels. This increases the amount of interaction of users with each other and increases the frequency with which users interact within the social networking system 140.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions is stored in the action log 210. Examples of interactions with objects include: commenting on posts, sharing links, and checking-in to physical locations via a mobile device, accessing content items, and any other interactions. Additional examples of interactions with objects on the social networking system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user profile of the user and allowing a more complete understanding of user preferences.

The action log 220 may also store user actions taken on a third party system 130, such as an external website, and communicated to the social networking system 140. For example, an e-commerce website that primarily sells sporting equipment at bargain prices may recognize a user of a social networking system 140 through a social plug-in enabling the e-commerce website to identify the user of the social networking system 140. Because users of the social networking system 140 are uniquely identifiable, e-commerce websites may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, an edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system, sharing a link with other users of the social networking system, and commenting on posts made by other users of the social networking system.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad campaign store 245. An advertisement request includes advertisement content and a bid amount. The advertisement content is text, image, audio, video, or any other suitable data presented to a user. The advertisements may include an advertisement to purchase a restricted gift for another user. In various embodiments, the advertisement content also includes a landing page specifying a network address to which a user is directed when the advertisement is accessed. The bid amount is associated with an advertisement by an advertiser and is used to determine an expected value, such as monetary compensation, provided by an advertiser to the social networking system 140 if the advertisement is presented to a user, if the advertisement receives a user interaction, or based on any other suitable condition. For example, the bid amount specifies a monetary amount that the social networking system 140 receives from the advertiser if the advertisement is displayed and the expected value is determined by multiplying the bid amount by a probability of the advertisement being accessed.

Additionally, an advertisement request may include one or more targeting criteria specified by the advertiser. Targeting criteria included in an advertisement request specify one or more characteristics of users eligible to be presented with content in the advertisement request. For example, targeting criteria are a filter to apply to fields of a user profile, edges, and/or actions associated with a user to identify users having user profile information, edges or actions satisfying at least one of the targeting criteria. Hence, the targeting criteria allow an advertiser to identify groups of users matching specific targeting criteria, simplifying subsequent distribution of content to groups of users.

In one embodiment, the targeting criteria may specify actions or types of connections between a user and another user or object of the social networking system 140. The targeting criteria may also specify interactions between a user and objects performed external to the social networking system 140, such as on a third party system 130. For example, the targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in the targeting criteria allows advertisers to further refine users eligible to be presented with content from an advertisement request. As another example, targeting criteria may identify users having a connection to another user or object or having a particular type of connection to another user or object.

In one embodiment, the social networking system 140 identifies stories likely to be of interest to a user through a “newsfeed” presented to the user. A story presented to a user describes an action taken by an additional user connected to the user and identifies the additional user. In some embodiments, a story describing an action performed by a user may be accessible to users not connected to the user that performed the action. The newsfeed manager 235 may generate stories for presentation to a user based on information in the action log 220 and in edge store 225 or may select candidate stories included in content store 210. One or more of the candidate stories are selected and presented to a user by the newsfeed manager 235.

For example, the newsfeed manager 235 receives a request to present one or more stories to a social networking system user. The newsfeed manager 235 accesses one or more of the user profile store 205, the content store 210, the action log 220, and the edge store 225 to retrieve information about the identified user. For example, stories or other data associated with users connected to the identified user are retrieved. The retrieved stories or other data is analyzed by the newsfeed manager 235 to identify content likely to be relevant to the identified user. For example, stories associated with users not connected to the identified user or stories associated with users for which the identified user has less than a threshold affinity are discarded as candidate stories. Based on various criteria, the newsfeed manager 235 selects one or more of the candidate stories for presentation to the identified user.

In various embodiments, the newsfeed manager 235 presents stories to a user through a newsfeed, which includes a plurality of stories selected for presentation to the user. The newsfeed may include a limited number of stories or may include a complete set of candidate stories. The number of stories included in a newsfeed may be determined in part by a user preference included in user profile store 205. The newsfeed manager 235 may also determine the order in which selected stories are presented via the newsfeed. For example, the newsfeed manager 235 determines that a user has a highest affinity for a specific user and increases the number of stories in the newsfeed associated with the specific user or modifies the positions in the newsfeed where stories associated with the specific user are presented.

The newsfeed manager 235 may also account for actions by a user indicating a preference for types of stories and selects stories having the same, or similar, types for inclusion in the newsfeed. Additionally, newsfeed manager 235 may analyze stories received by social networking system 120 from various users and obtains information about user preferences or actions from the analyzed stories. This information may be used to refine subsequent selection of stories for newsfeeds presented to various users.

The web server 230 links the social networking system 140 via the network 120 to the one or more client devices 110, as well as to the one or more third party systems 130. The web server 140 serves web pages, as well as other web-related content, such as JAVA®, FLASH®, XML, and so forth. The web server 230 may receive and route messages between the social networking system 140 and the client device 110, for example, instant messages, queued messages (e.g., email), text messages, short message service (SMS) messages, or messages sent using any other suitable messaging technique. A user may send a request to the web server 230 to upload information (e.g., images or videos) that are stored in the content store 210. Additionally, the web server 230 may provide application programming interface (API) functionality to send data directly to native client device operating systems, such as IOS®, ANDROID™, WEBOS®, or RIM®.

Audience information is generated by an audience analytics module 240. The audience analytics module 240 generates audience metrics to provide a comparison between a benchmark audience and a target audience in the social networking system 140. Each audience is defined by a set of user characteristics describing characteristics of the users that are to be included in the audience. For example, the benchmark audience may be all users that live in the United States and the target audience may be all users that live in the United States and are associated with an interest in soccer. In this example, the audience metrics provide comparison information for user characteristics that differ with respect to the users that like soccer.

The target audience may be a subset of the benchmark audience, as in the above example. When the target audience is a subset of the benchmark audience, the user characteristics describing the target audience include the user characteristics of the benchmark and at least one additional user characteristic. In one common use, the additional user characteristics of the target audience are users that are associated with a particular page or event on the social networking system 140. For example, the target audience may include the benchmark users that “like” a page of the advertiser. This may permit an advertiser to view audience metrics for users in an audience that interact with the advertiser (via the event or page) and view differences in user characteristics relating to the interaction. This permits an advertiser to discover, for example, that the users that like the advertiser's product tend to be more affluent than those who do not like the product, live in California, and are more likely to have an interest in a particular type of music, for example.

In other examples, the target audience is not a subset of the benchmark audience. Rather, the target audience and benchmark audience in these examples may describe different user attributes. For example, the benchmark audience for a soccer advertiser may be defined as women 25-35 that like soccer, and the target audience may be defined as women 35-45 that like soccer. By identifying audience metrics between these groups, the advertiser can identify how attributes of 35-45 group differ from the 25-35 group, potentially permitting the advertiser to modify an advertisement that was originally targeted to the 25-35 group to instead be targeted to the 35-45 group.

In another example, the advertiser provides user information to the audience analytics module 240. The advertiser may have its own database of customer information or other source of customer data and wish to use the available audience analytics of the social networking system 140. In this example, the user information provided by the advertiser is received by the audience analytics module 240 and used to identify users for the target audience. The user information provided by the advertiser may be identifying information about a user or a number of users, such as an email address, name, or other identifier. The user information received from the advertiser may be a hashed value and a designation of the user information that is hashed. The audience analytics module 240 hashes the same information stored at the user profile store 205 to determine which users of the social networking system 140 match the user information provided by the advertiser. The matched users are selected as members of the target audience. Stated another way, the user characteristics that define the target audience in this example are the user information provided by the advertiser. This permits the advertiser to receive audience metrics for customers of the advertiser and generate a custom audience specific to that advertiser. The advertiser can thus upload to the social networking system 140 a custom audience for which the advertiser can then use the system to analyze and obtain metrics for the audience or compare the audience to other audiences within the social networking system 140

Prior to calculating audience metrics, the audience analytics module 240 may exclude certain users and also generalize data to protect user privacy. For example, the audience analytics module 240 in one configuration excludes users that are under a threshold age, such as 18, from appearing in any analytics results. In addition, the resulting audience metrics are displayed as falling within a range rather than provide a precise number of users with a particular user characteristic. Thus, users having a given income may be displayed as falling in a range of 150 k-200 k users, rather than a specific number of 158,148.

The audience analytics module 240 provides the advertiser 150 with the user characteristics defining the benchmark audience and the user characteristics defining the target audience. The audience analytics module 240 receives selections from the advertiser 150 to modify the user characteristics of the benchmark audience or the target audience and generates audience metrics to compare user characteristics of the audiences. As the user views the audience metrics in an interface, the user may select an audience metric to add the audience metric to the user characteristics describing either audience, permitting the user to quickly amend the target audience or benchmark audience to determine characteristics of those particular users. The audience analytics module 240 may continue to receive additional selections from the advertiser and modify the benchmark or target audiences. This permits a user to quickly select and “drill down” on a particular desired audience, as well as to see how that audience differs from the benchmark audiences.

The audience metrics may be generated for many different types of user characteristics, such as demographics, purchasing information, social networking actions, interests, and so forth. As described above, many user characteristics are self-reported by users. Other user characteristics may be obtained by the social networking system from a third-party data source. This third-party data may only match a portion of the users in an audience, and may be extrapolated to describe the users in the audience as a whole. In addition, user characteristics may include characteristics derived from other data about a user. For example, interests of the user may include inferred interests in addition to self-described interests of the user. For example, a user's interactions with a particular page may be used to infer an interest in the subject matter of the page.

For certain user characteristics, the audience metric indicates the percentage change between the benchmark audience and the target audience of users exhibiting that user characteristic. For other user characteristics, the audience metric indicates the distribution of users from a selection of user characteristics. For example, users may only be associated with one location as a place of residence, which may be limited to a specific set of locations (e.g., states in a country). The audience metrics may indicate the how the distribution of user locations differs among the selection for users in the benchmark audience and the target audience.

In one type of audience metric, an affinity score is measured that identifies the increased (or decreased) likelihood between the benchmark and target audiences that a user is associated with a user characteristic as a ratio. These affinity scores may be calculated for individual pages of the social networking system 140, for example, respective to individual pages liked by users. Affinity scores may also be calculated for interests and user interactions on the social networking system 140. For example, the affinity score may indicate that target audience users are 5.8 times more likely to like a specific page in the social networking system relative to benchmark users.

The affinity scores may be particularly useful to an advertiser when the target users are users that are associated with the advertiser in the social networking system 140, for example members of the benchmark audience that have liked a page of the advertiser. The affinity score permits the advertiser to view the interests and pages of the users that like the advertiser's page, and how those interests differ from the interests and pages of the benchmark users generally. For example, the user characteristics of the benchmark may specify users 25-35 who like soccer. The user characteristics of the target audience may specify the same users who also like a page of the advertiser. By identifying the affinity scores of the target audience relative to the benchmark (i.e., the users that like the advertiser relative to those users that do not) the advertiser can identify that its fans are also likely to like a specific soccer player, or a video game relating to soccer.

The affinity score may also be adjusted for the relative frequencies that the target audience and the benchmark are associated with other user characteristics. Different audiences have different frequencies of interacting with objects in the social networking system 140, which may not reflect true interest levels of the audiences. For example, in one audience, users very frequently like pages on the social networking system, and in another audience, users rarely like pages on the social networking system. This means that while the first group may have a high raw percentage of users that like the page, and the latter group may have a lower raw percentage, the latter group may actually be more interested in the page because the latter group less frequently likes any pages. To account for this, in one embodiment the frequency of users in an audience that like a page is adjusted for the total frequency of likes in a page to calculating an affinity score. More generally, the user characteristic for the affinity is categorized as a type of user interaction, in this example “page likes,” and the total frequency is measured relative to the frequency of that type of user interaction. In other examples, the user interaction type may be posting to a page, sending a message, attending an event, and so forth. In one embodiment, an affinity score is calculated as follows:

$${A}_{C} = \frac{\frac{{T}_{C}}{{T}_{C} ⋃ {B}_{C}}}{\frac{{I}_{T}}{{I}_{T} ⋃ {I}_{B}}} = \frac{\frac{{T}_{C}}{{I}_{T}}}{\frac{{T}_{C} ⋃ {B}_{C}}{{I}_{T} ⋃ {I}_{B}}} \qquad Equation 1$$

### Wherein:

Ac is the affinity score for user characteristic C relative to target audience T and benchmark audience B;
T_{C} is the number of users in the target audience with user characteristic C;
B_{C} is the number of users in the benchmark audience with user characteristic C;
I_{T} is the total number of interactions of the interaction type performed by the target audience;
I_{B} is the total number of interactions of the interaction type performed by the benchmark audience.

As stated by Equation 1, the affinity score in this embodiment is calculated as: the ratio of the number of users in the target audience with user characteristic C to the total number of interactions of the interaction type performed by the target audience, divided by the ratio of number of users in union of the target audience and benchmark audience with user characteristic C to the total number of interactions of the interaction type performed by the union of the target audience and benchmark audience.

In addition to an affinity score, a relevancy score may also be calculated for the specified user characteristic. The relevancy store indicates, relative to that user characteristic, a measure of an affinity score and the number of users in the target audience. For example, certain user characteristics may have a high affinity but a relatively low number of total users, indicating that targeting that user characteristic may not be particularly valuable, despite its affinity score, because it has few users associated with it. In one embodiment, the relevancy score is calculated as:

$${R}_{C} = \frac{{T}_{C}}{T} * ( {A}_{C} - 1 ) \qquad Equation 2$$

### Wherein:

R_{C} is the relevancy score for a user characteristic C;
Tc is number of users in the target audience T with user characteristic C;
Tis the number of users in the target audience; and
Ac is the affinity score for user characteristic C.

As stated by Equation 2, in this embodiment the relevancy store for a user characteristic is equal to the number of users in the target audience with the user characteristic divided by the number of users in the target audience, multiplied by the affinity score for the user characteristic minus one. The relevancy score may be used to select an ordering of user characteristics to be shown to the user, displayed to the user to provide additional information relating to a user characteristic, and may be used to determine which user characteristics to analyze.

In some cases, the social networking system 140 has millions or billions of user characteristics among the social networking system and for which an affinity score and relevancy score may be generated. For example, the social networking system 140 may maintain billions of pages that may be interacted with by a user, each of which may be a user characteristic that may be of interest to an advertiser. In one embodiment, the user data is stored across a plurality of leaf nodes comprising a computing device, each analyzing data relating to a portion of the users of the social networking system 140. The computation of affinity and relevance scores may be calculated locally by individual leaf nodes, which generate candidate user characteristics with respect to users associated with that leaf node. The candidate user characteristics are those user characteristics that have affinity and/or relevance scores that are outliers from norm, for example relatively high or low scores. Each leaf node selects candidate user characteristics, which are further aggregated to identify in characteristics of the remaining users.

In these ways, the audience analytics module 240 generates and presents analytics information to advertisers. The interfaces and operation of audience analytics module 240 is further described below with respect to further Figures of this disclosure.

The ad creation module 250 provides advertiser 150 with interfaces for generating ad requests with advertisements to be provided to users of the social networking system 140. The interface provided by the ad creation module 250 permits the advertiser 150 to designate an advertisement, targeting criteria, and bid for an advertisement. The ad creation module 250 in this embodiment provides targeting criteria to the audience analytics module 240 to generate audience metrics for the targeting criteria. The audience metrics may be generated with the targeting criteria as the user characteristics defining the target audience, and the benchmark selected as all users of the social networking system 140. The ad creation module 250 provides the audience metrics for the targeting criteria to the advertiser to illustrate to the advertiser, during the advertising selection process, characteristics of the users being targeted by the advertisement.

In addition, the ad creation module 250 may direct the advertiser to the interfaces provided by the audience analytics module 240 to further review and analyze potential target audiences. After interaction with the audience analytics module 240, the advertiser may select a benchmark audience or target audience to which the advertiser would like to advertise. In this case, the audience analytics module 240 provides the selected audience and its defining user characteristics to the ad creation module 250. The ad creation module 250 receives the user characteristics of the selected audience and sets the received audience characteristics as the targeting criteria for an advertisement. In this way, a user can interact with the analytics module to understand an audience, and then directly add that audience as targeted users of an advertisement.

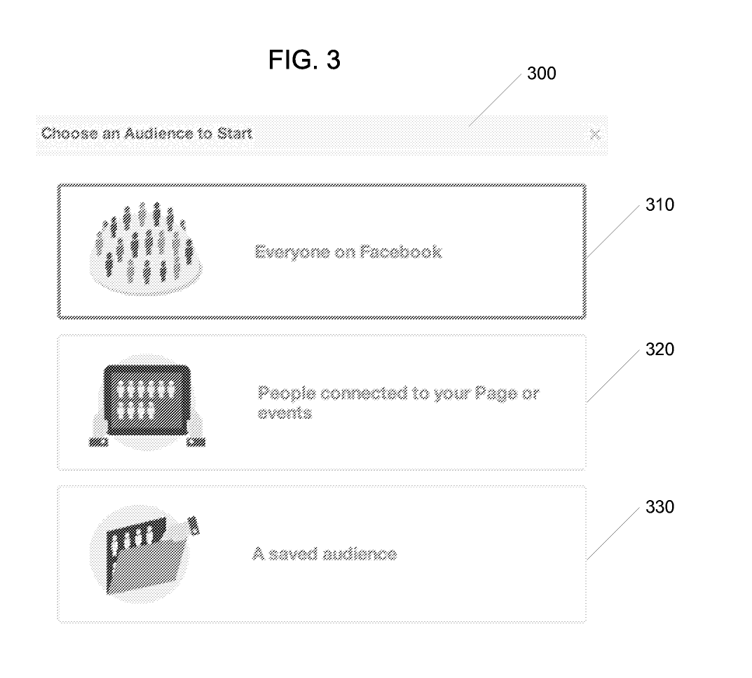

FIG. 3 shows an interface 300 for selecting audiences provided by the audience analytics module 240. In this interface, an advertiser may make initial selections for a target audience and a benchmark audience. Using interface element 310, the advertiser may select a benchmark audience that includes the users of the social networking system 140 as a whole. When the advertiser selects interface element 310, the audience analytics module 240 sets the user characteristics of the benchmark and target audiences to permit inclusion of all users of the social networking system. As the user interacts with the interfaces provided by the audience analytics module 240, the user may select and refine the target audience as described herein. Using interface element 320, the advertiser may select a target audience that includes users that like a specific page or event associated with the advertiser. Users may also access saved audiences via interface element 330, such as audiences used in prior analyses or custom audiences uploaded by the advertiser.

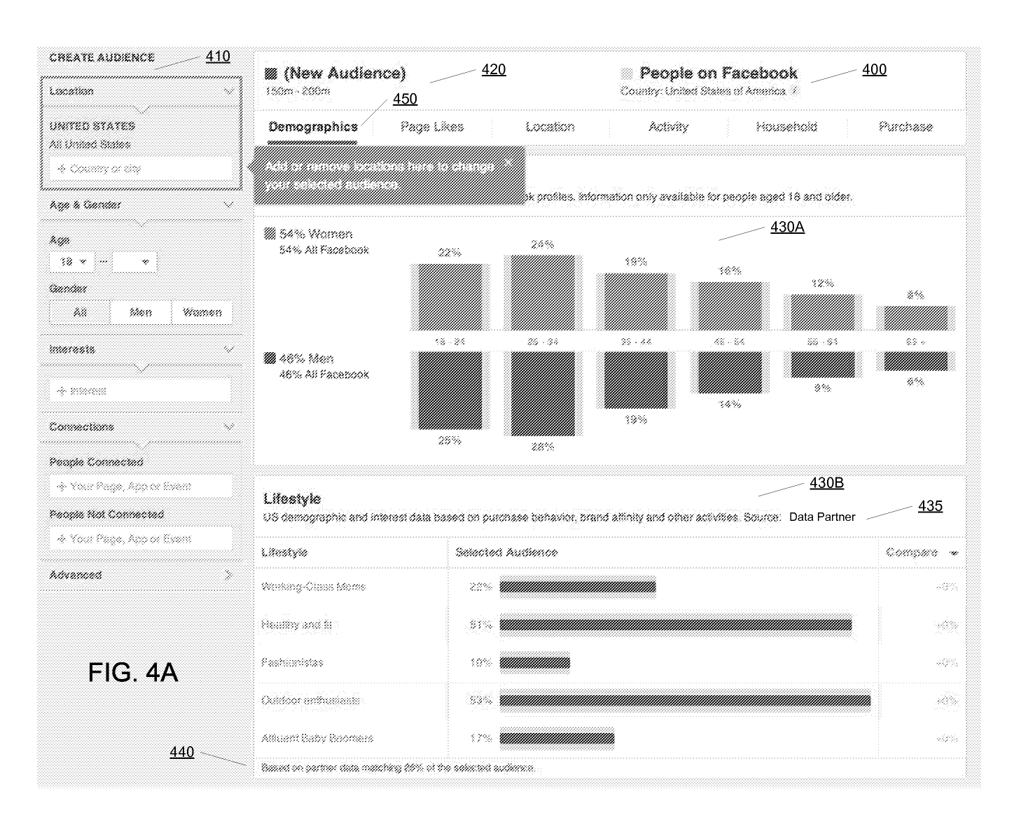

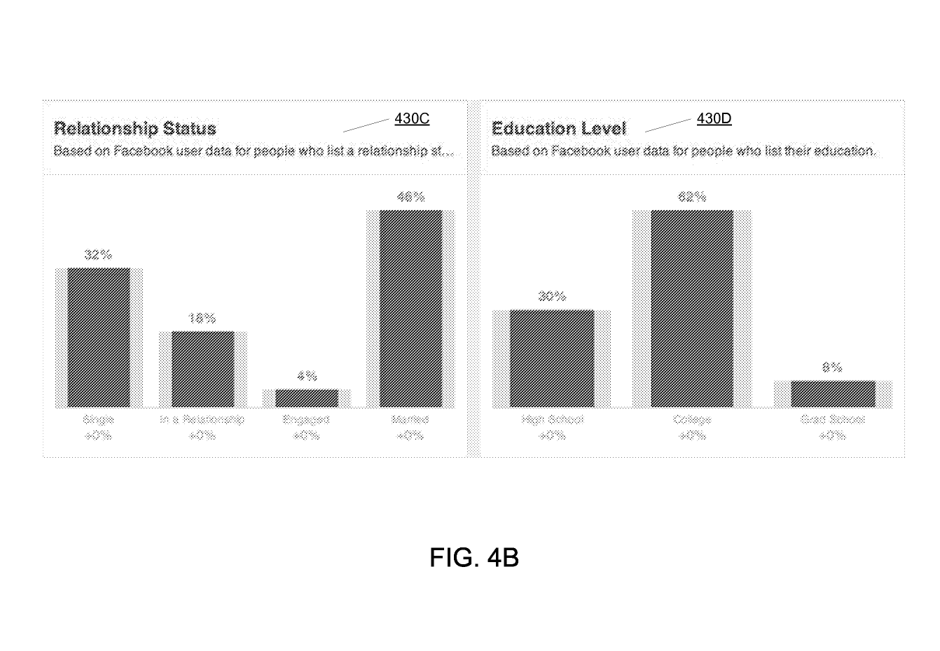

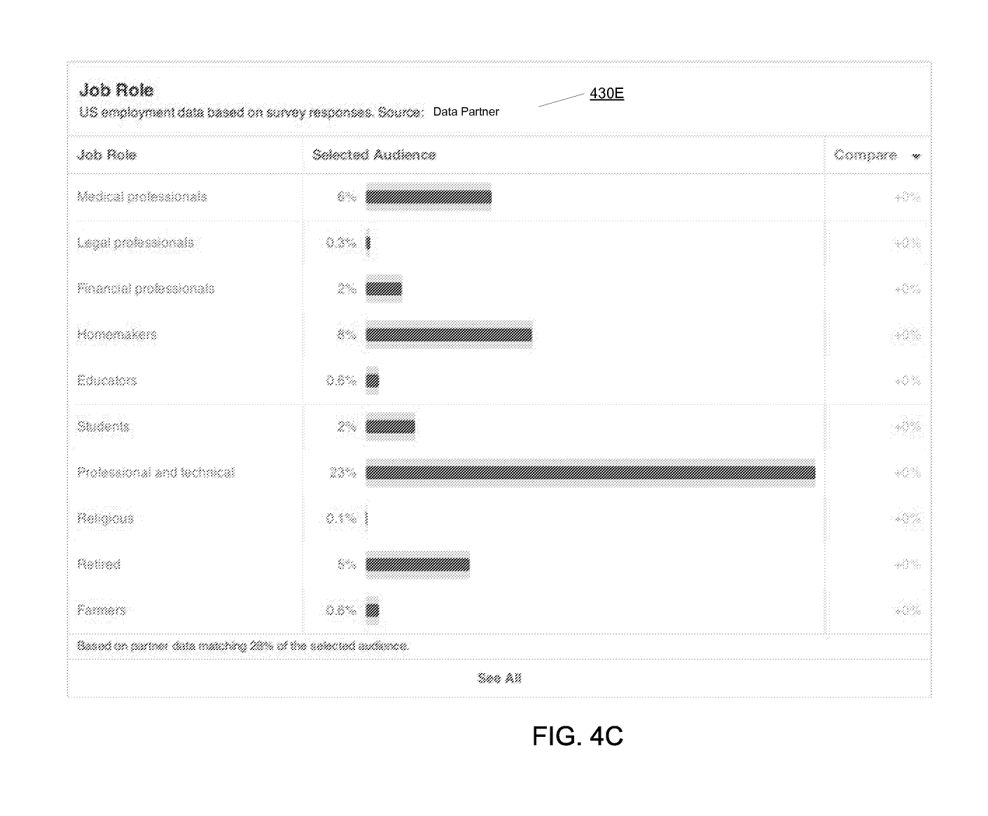

FIGS. 4A-4C show example user interfaces for viewing audience metrics. The interfaces shown in FIGS. 4A-4C illustrate interfaces for reviewing an audience metrics for users prior to entry of user characteristics for the target audience. In the example shown in these Figures, the target audience is the same set of users as is used for the benchmark audience. Thus, the data shown in the display are the metrics for the benchmark audience itself.

In the display shown in FIG. 4A, a benchmark audience 400 is shown and can be compared to a target audience 420, though in this case a target audience different from the benchmark audience has not yet been selected. The benchmark audience 400 in this example includes the users of the social networking system 140 in a particular country, in this case the United States. Details of the target audience 420 that could be selected are also shown and may include a range of the number of users included in the target audience, in this example 150-200 million users.

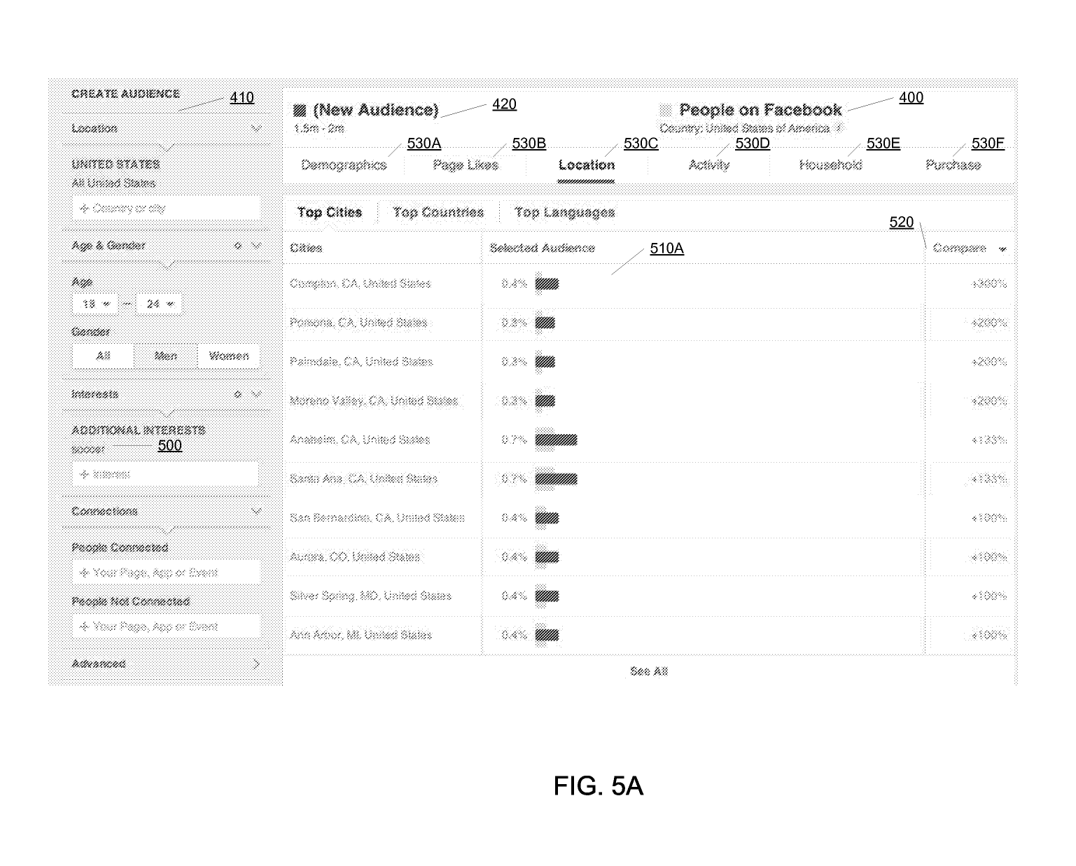

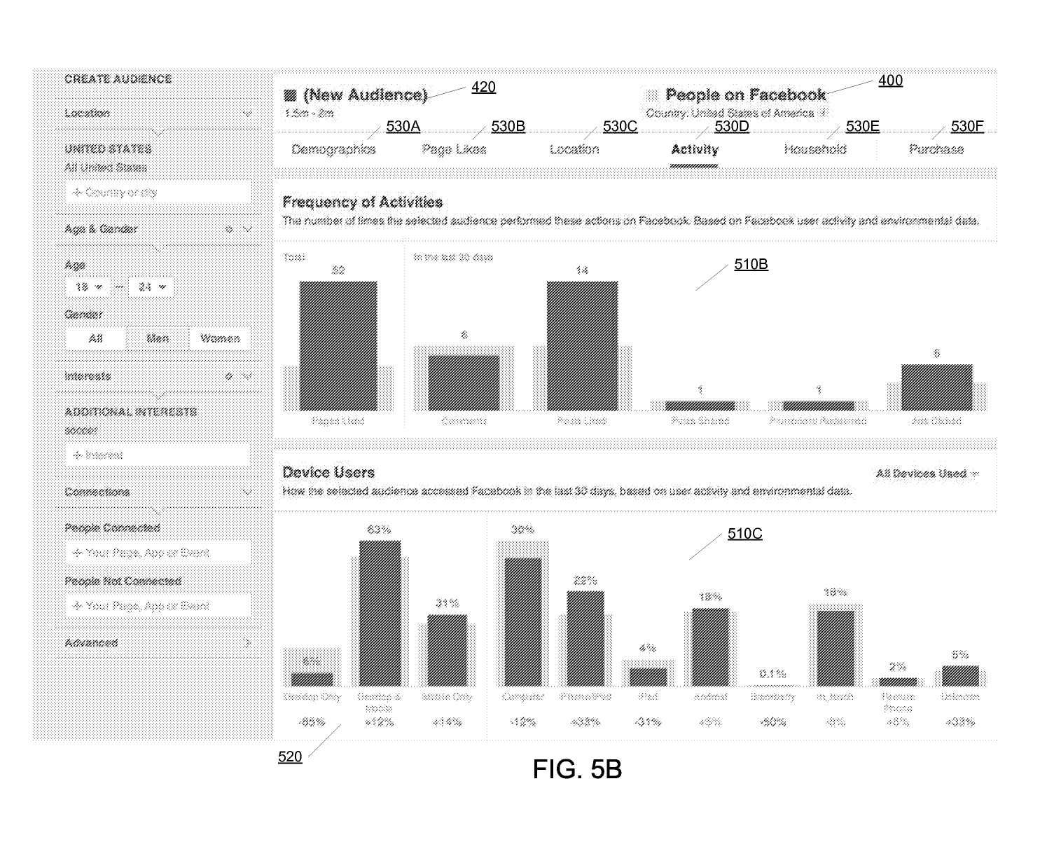

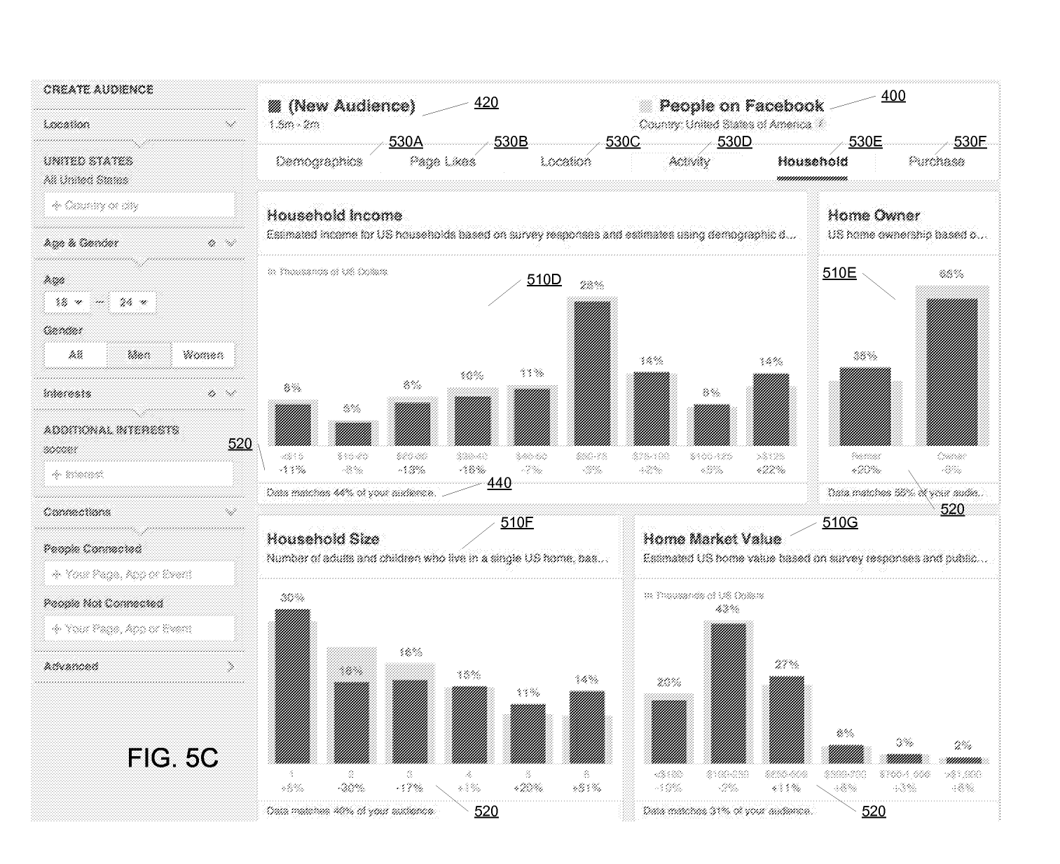

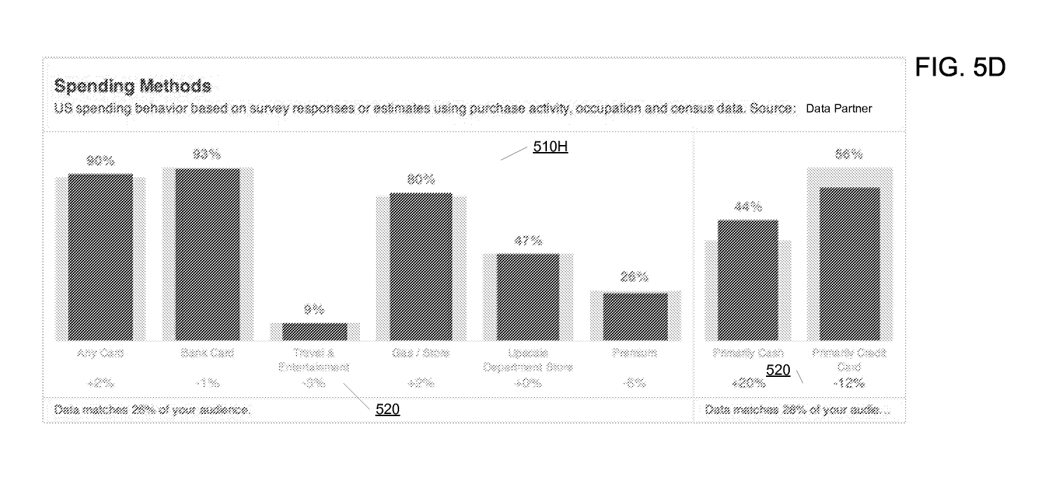

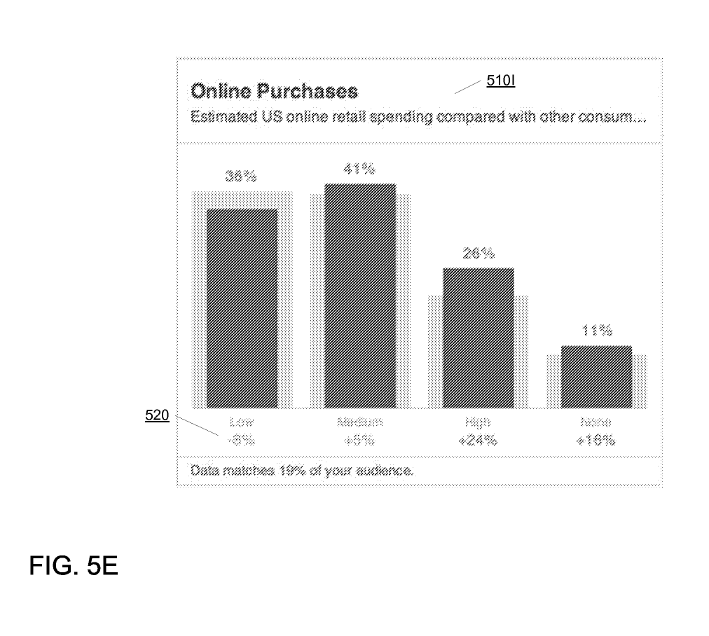

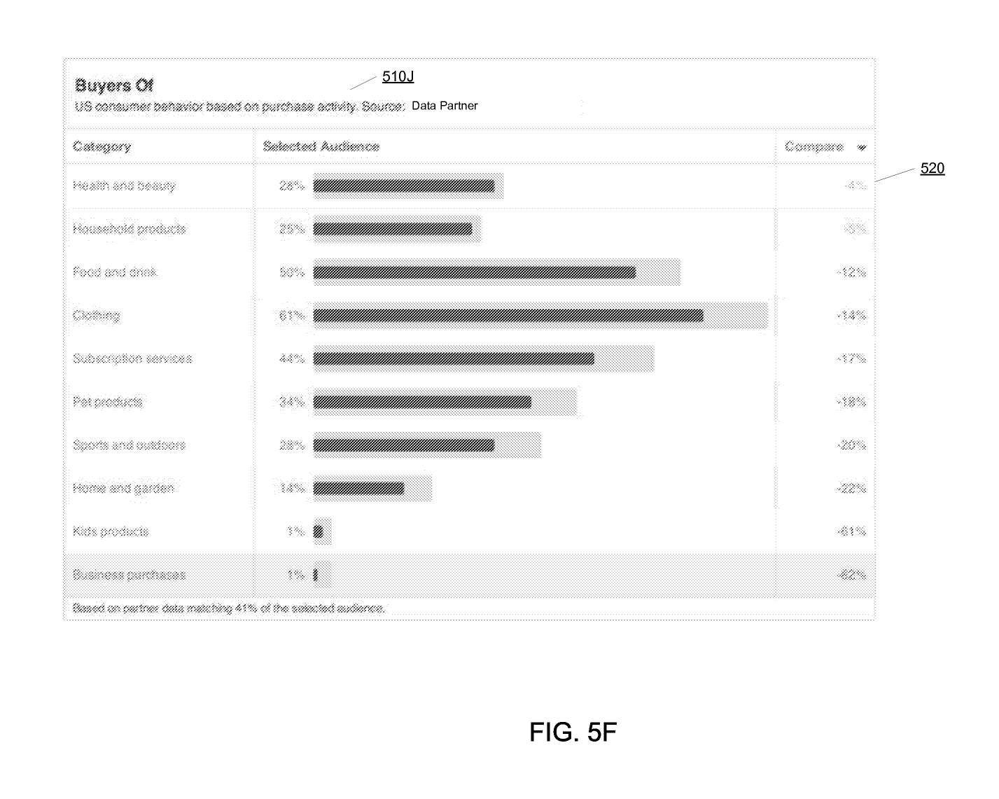

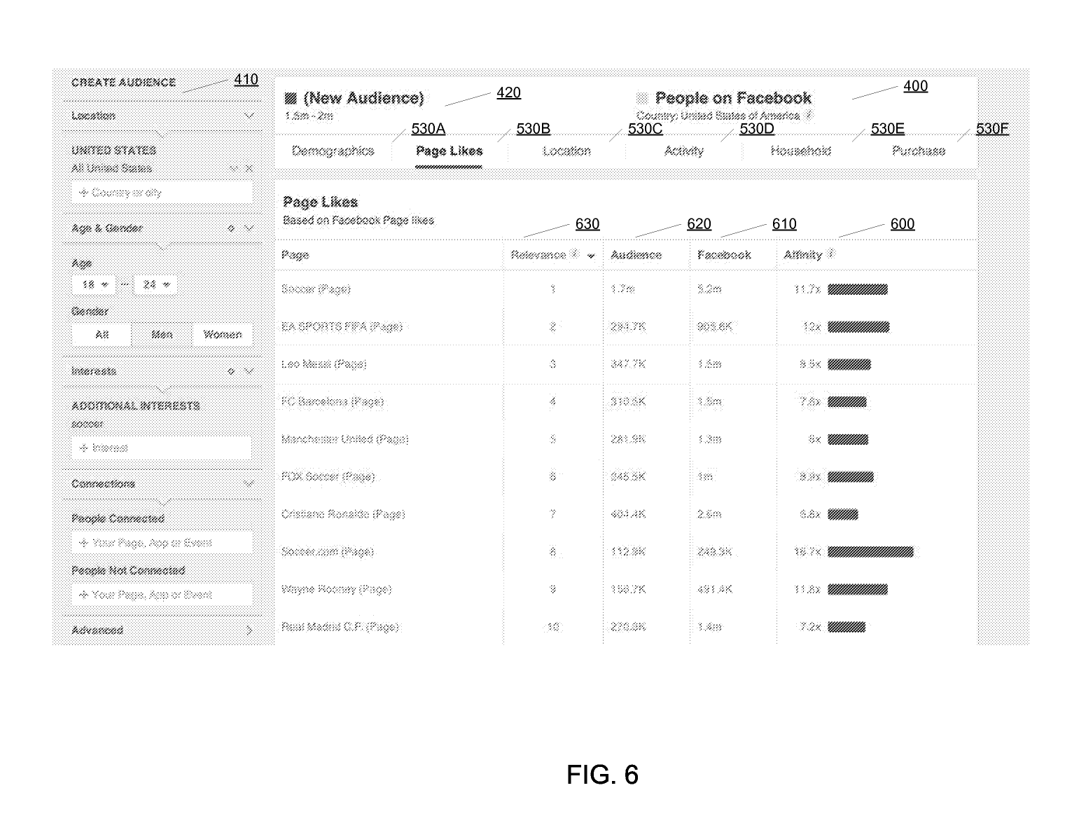

As shown in the user interfaces of FIGS. 4A-4C, audience metrics 430A-E (generally, audience metrics 430) are visually displayed to the advertiser to illustrate the distribution of user characteristics for users. Examples of these audience metrics 430 include any audience metrics described herein, including those further shown as audience metrics 510 shown with respect to FIGS. 5A-5F. In the examples shown in FIGS. 4A-4C, the audience metrics include an age and gender audience metric 430A, lifestyle audience metric 430B, relationship status audience metric 430C, education level audience metric 430D, and job role 430E. The advertiser may navigate to different types of audience metrics using the interface 450, in this example to demographics, page likes, location, activity, household information, and purchasing information. FIGS. 4A-4C illustrate some of these types of audience metrics, while further audience metrics are shown with respect to FIGS. 5A-6.

As noted above, certain user data for audience metrics may be provided by a partner of the social networking system 140. A data source indication 435 provides the source of the underlying user data, and a further indication 440 displays the percentage of users in the audience that are associated with the data from the data source. Thus, this permits an advertiser to determine the likely reliability of the information provided in the indicated metric, for example whether the advertiser trusts the specific data partner and whether the percentage of users matching that audience is sufficient for analyzing the audience as a whole.

The user interface includes an audience interface 410 for modifying the user characteristics of the target audience. Using the audience interface 410, the advertiser may provide user characteristics to modify the target audience, specifying for example a particular age range, gender, interests, etc. The user characteristics specified by an advertiser may also include specific pages, persons, purchases, and any other user characteristic tracked by the social networking system as further described above. For example, an advertiser may specify user characteristics including users that are in-market for or have just purchased a particular product. When a user selects or modifies a user characteristic in the audience interface 410, the audience analytics module 240 receives the user's selection and updates the target audience with the newly-selected user characteristics. The audience metrics 430 are updated with the newly selected target audience.

In addition to selecting user characteristics for the target audience in audience interface 410, the advertiser may also select user characteristics by interacting with specific audience metrics 430. For example, an advertiser may select a specific gender and age in the age and gender audience metric 430A, such as women 35-44, or a specific lifestyle in the lifestyle audience metric 430B. Selected audience metrics are added to the user characteristics of the target audience to update the target audience accordingly. This permits a user to quickly interact with the audience metrics interface to identify specific characteristics of the desired audience. In some configurations, certain audience metrics cannot be selected as user characteristics for a target audience. For example, a data partner may prohibit specific identification of the users to which it has data, or prohibit addition of such data as target audience characteristics.

While described with respect to modifying the target audience, the user may also interact with the audience interface 410 or select individual audience metrics to modify the benchmark audience. In one example, the target audience is the benchmark audience that likes a specific page of the advertiser, and the advertiser interacts with the audience interface 410 to modify the benchmark audience from which the target audience is selected. As noted above, the target audience may or may not be a subset of the benchmark audience, and in one embodiment the advertiser may interact with an interface to independently set each of the benchmark and target audiences. For example, the audience interface 410 may be duplicated to modify each audience individually, or may include a toggle to select which audience is being modified at any given moment.

FIGS. 5A-5F illustrate an example interface for viewing audience metrics of a target audience and a benchmark audience. In this example, the target audience has been selected to select users that have the user characteristic of being male within the age of 18-24 and having an interest 500 in soccer. As noted by the target audience 420, this target audience falls within the range of 1.5-2 million users of the social networking system 140. In this example, the benchmark audience 400 is all users of the social networking system 140 that reside in the United States. Audience metrics 510 are generated by the audience analytics module 240 and displayed to the user. The audience metrics 510 indicate the difference between the benchmark audience 400 and the target audience 420 with respect to the associated user characteristic. The interface may display the audience metric as a bar graph comparison, as shown by audience metric 510, or may show the audience metric as a percentage change, as shown by percentage 520. In the interfaces of FIGS. 5A-5F, the lighter bar in audience metric 510 represents the benchmark audience and the darker bar represents the target audience. As shown by the interfaces in FIGS. 5A-5F, the target and benchmark audiences differ across many types of user characteristics.

The interface provides a selection of tabs 530A-F (generally, tab 530) indicating categories of audience metrics for the advertiser to review. In these examples, the tags 530 include categories for demographics tab 530A, page likes tab 530B, location tab 530C, activity tab 530D, household information tab 530E, and purchases tab 530F. The various tabs 530 organize audience metrics 510 for viewing by the advertiser. In other variations, more or fewer tabs 530 may be provided with differing categories of audience metrics. Demographics information for demographics tab 530A is shown with respect to FIGS. 4A-4C and audience metrics 430.

FIG. 5A shows the location tab 530C and location metric 510A. The location metric indicates individual locations associated with a residence of a user, for example specific cities in which users may live.

FIG. 5B shows the activity tab 530D and metrics indicating activities performed by users in the social networking system 140. For example, the activity tab 530D includes activity frequency metric 510B, which indicates the frequency that activities, such as comments, post likes, page likes, and other actions on the social networking system are performed. The activity tab may also include device use metric 510C, which indicates the frequency that a user accesses the social networking system 140 from various types of devices.

FIG. 5C shows the household tab 530E and metrics indicating audience metrics relating to household demographics. The audience tab 530E may include an income metric 510D indicating household income, home ownership metric 510E indicating ownership or rental of the user's residence, household size metric 510F indicating the number of persons in the user's residence, and estimated home value metric 510G indicating an approximate value of the residence in which a user lives.

FIGS. 5D-F show metrics that may be included in the purchases tab 530F. These may include spending pattern metric 510H indicating purchasing habits such as types of spending by users, online purchase activity metric 510I indicating purchase online purchase activity at various spending levels, and purchase category metric 510J indicating the type of products purchased by users.

FIG. 6 illustrates a display of audience metrics including affinity scores 600 according to one embodiment. In this example, the audience metrics are displayed with the page likes tab 530B. When audience metrics include affinity scores 600, the audience analytics module 240 determines which user characteristics to provide in the display to the user. As indicated above, in some examples, the user characteristics for which affinity scores 600 are calculated include interactions in the social networking system 140 with various objects in the social networking system 140, for which there may be millions or billions of objects. The audience analytics module 240 selects a set of these objects for presentation with affinity scores 600. In this example, the user characteristics for which affinity scores are calculated include page likes by the users, and audience analytics module 240 selects a set of objects based on the relevancy score 630 associated with the page. In this example, the user interface includes an ordered list of user characteristics (page likes) by relevance score 630. The user interface may also display the number of users 620 in the audience that have the user characteristic. The user interface may also display the number of users 610 in the benchmark that have the user characteristic. Using this display, the advertiser can quickly and easily identify user interactions within the social networking system and relative frequency of interaction with particular pages relative to the benchmark.

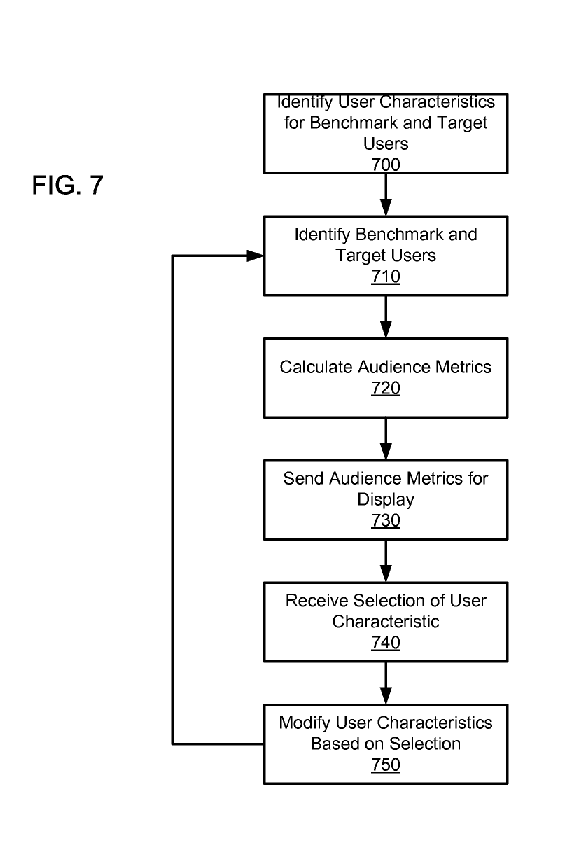

FIG. 7 shows an example method for generating audience metrics and displaying the audience metrics to a user. This example method may be performed by the audience analytics module 240. The audience analytics module 240 receives or identifies 700 user characteristics for the benchmark and target users. Next, the audience analytics module 240 accesses the user profile store 205 with the specified user characteristics to identify 710 the benchmark and target users meeting the specified user characteristics. Using the identified users in the target audience and the users in the benchmark audience, the audience analytics module 240 calculates audience metrics 720 and sends 730 the audience metrics for display. When the advertiser views the audience metrics, the advertiser may select and send user characteristics to the audience analytics module 240 to modify user characteristics of the benchmark or target audience. The audience analytics module 240 receives 740 the selection of user characteristics and modifies the user characteristics of the target audience. Using the modified user characteristics, the audience analytics module 240 identifies 710 benchmark and target users for the modified user characteristics and updated audience metrics.

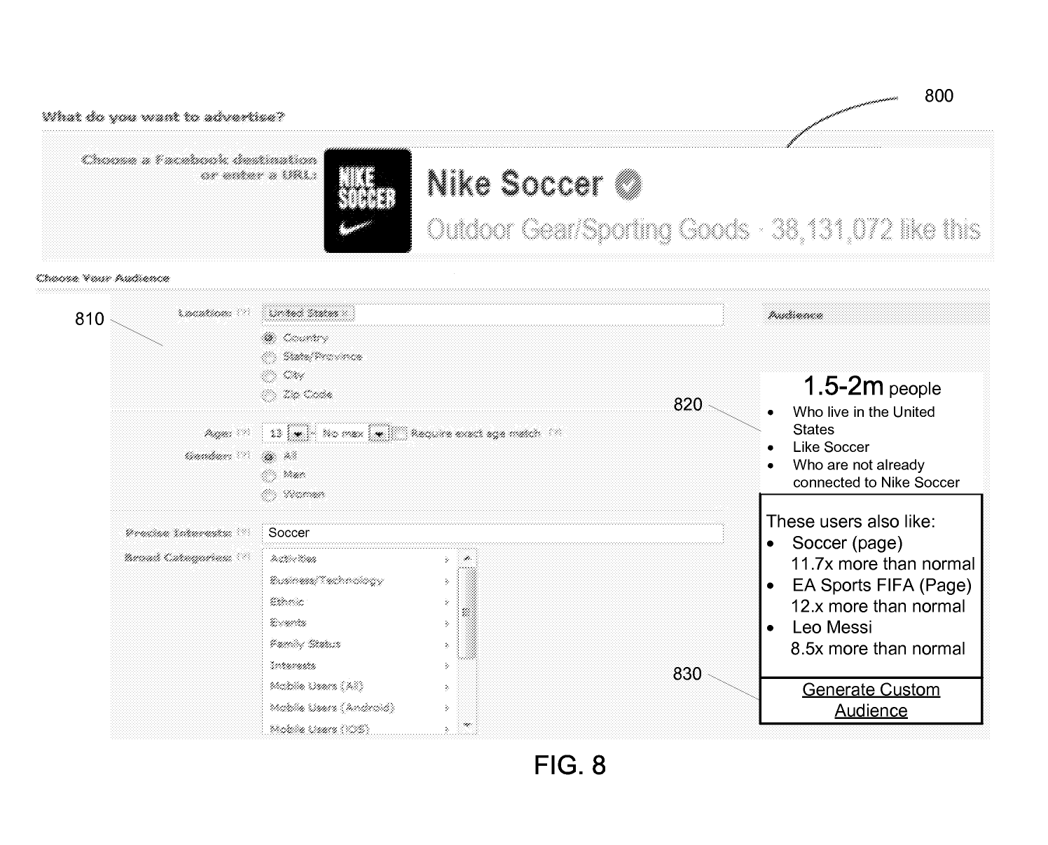

FIG. 8 shows an example interface for a user to generate an advertising request. This interface may be generated and provided to the advertiser by the ad creation module 250. The advertiser may interact with this interface to provide an advertisement and provide targeting criteria for the advertisement to the social networking system 140. The advertiser may select a specific page on the social network as the target 800 for the advertisement. The interface also provides an interface for entering targeting criteria 810 for the advertisement. As the user enters targeting criteria to the interface, the ad creation module 250 provides the targeting criteria to the audience analytics module 240 to determine audience metrics for the selected targeting criteria. The ad creation module 250 receives the audience metrics and may provide some audience metrics 820 to the advertiser, which may include affinity scores and other interactions in the social network made by the targeted users. In addition, the advertiser may select an interface element 830 to generate a custom audience. When an advertiser selects the custom audience interface 830, the advertiser is provided an interface to select user characteristics to view target and benchmark audiences as shown in FIGS. 4A-5F. When user selects a desired target audience, the target audience is entered to the advertising interface and the associated user characteristics are selected as targeting criteria for the advertisement. In this way, an advertiser may view user characteristics of the users targeted by an advertisement and easily modify the targeting criteria while exploring target audience metrics. An advertiser may also enter an advertising purchase flow while viewing the audience metrics as shown in FIGS. 5A-5F. The advertiser may select an option to purchase an advertisement targeting the target audience with an advertisement. After receiving the selection to purchase the advertisement, targeting criteria for the advertisement may be populated with the user characteristics of the target audience.

In one embodiment, the user characteristics 820 for display to the user are selected by the ad creation module 250 based on the audience metric. For example, the user characteristics may be selected as the user characteristics that differ most significantly from the benchmark audience, or a set of user characteristics with the highest affinity score or highest relevancy score.

### CONCLUSION

Though described with respect to a social networking system 140, the audience metrics and analysis described herein may be used for a variety of types of online advertising platforms and is not limited to the social networking context.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a benchmark audience of users of an online system and a target audience of users of the online system;
for each user interest of a plurality of user interests, generating an affinity score for the user interest by:
computing a first frequency of occurrence of the user interest for the users of the target audience,
computing a second frequency of occurrence of the user interest for the users of the benchmark audience,
comparing the first and second computed frequencies, and
generating the affinity score based on the comparison of the first and second frequencies;
selecting one or more outlier user interests from the user interests based on the generated affinity scores; and
providing the selected outlier user interests and the generated affinity score associated with the selected outlier user characteristics for display to a user device.

2. The method of claim 1, wherein generating the affinity score further comprises:
normalizing the affinity scores based on a frequency of user interests associated with the target audience relative to a frequency of user interests associated with the benchmark audience.

3. The method of claim 1, wherein the user interests comprise pages interacted with by the users of the online system.

4. The method of claim 1, wherein the user interests comprise events interacted with by the users of the online system.

5. The method of claim 1, wherein the one or more outliers are selected based on a ranking of the plurality of user interests by affinity scores.

6. The method of claim 1, wherein the affinity score is generated using the following equation:
$${A}_{C} = \frac{\frac{{T}_{C}}{{I}_{T}}}{\frac{{T}_{C} ⋃ {B}_{C}}{{I}_{T} ⋃ {I}_{B}}}$$
wherein
Ac is the affinity score for user interest C relative to target audience T and benchmark audience B;
T_{C} is the number of users in the target audience with user interest C;
B_{C} is the number of users in the benchmark audience with user interest C;
I_{T} is the total number of interactions of an interaction type corresponding to the user interest performed by the target audience; and
I_{B} is the total number of interactions of the interaction type performed by the benchmark audience.

7. The method of claim 1, further comprising generating a relevancy score for each user interest in the plurality of user interests, the relevancy score indicating the affinity score adjusted for the number of users in the target audience associated with the user interest.

8. The method of claim 7, wherein the relevancy score is used to select the one or more outlier user interests.

9. The method of claim 7, wherein the relevancy score is generated using the following equation:
$${R}_{C} = \frac{{T}_{C}}{T} * ( {A}_{C} - 1 )$$
wherein
R_{C} is the relevancy score for a user interest C;
Tc is number of users in the target audience T with user interest C;
Tis the number of users in the target audience; and
Ac is the affinity score for user characteristic C.

10. A non-transitory computer-readable medium comprising instructions that when executed by a processor cause the processor to perform steps of:
receiving a benchmark audience of users of an online system and a target audience of users of the online system;
for each user interest of a plurality of user interests, generating an affinity score for the user interest by:
computing a first frequency of occurrence of the user interest for the users of the target audience,
computing a second frequency of occurrence of the user interest for the users of the benchmark audience,
comparing the first and second computed frequencies, and
generating the affinity score based on the comparison of the first and second frequencies;
selecting one or more outlier user interests from the user interests based on the generated affinity scores; and
providing the selected outlier user interests and the generated affinity score associated with the selected outlier user characteristics for display to a user device.

11. The non-transitory computer-readable medium of claim 10, wherein generating the affinity score further comprises: normalizing the affinity scores based on a frequency of user interests associated with the target audience relative to a frequency of user interests associated with the benchmark audience.

12. The non-transitory computer-readable medium of claim 10, wherein the user interests comprise pages interacted with by the users of the online system.

13. The non-transitory computer-readable medium of claim 10, wherein the user interests comprise events interacted with by the users of the online system.

14. The non-transitory computer-readable medium of claim 10, wherein the one or more outliers are selected based on a ranking of the plurality of user interests by affinity scores.

15. The non-transitory computer-readable medium of claim 10, wherein the affinity score is generated using the following equation:
$${A}_{C} = \frac{\frac{{T}_{C}}{{I}_{T}}}{\frac{{T}_{C} ⋃ {B}_{C}}{{I}_{T} ⋃ {I}_{B}}}$$
wherein
Ac is the affinity score for user interest C relative to target audience T and benchmark audience B;
T_{C} is the number of users in the target audience with user interest C;
B_{C} is the number of users in the benchmark audience with user interest C;
I_{T} is the total number of interactions of an interaction type corresponding to the user interest performed by the target audience; and
I_{B} is the total number of interactions of the interaction type performed by the benchmark audience.

16. The non-transitory computer-readable medium of claim 10, the steps further comprising generating a relevancy score for each user interest in the plurality of user interests, the relevancy score indicating the affinity score adjusted for the number of users in the target audience associated with the user interest.

17. The non-transitory computer-readable medium of claim 16, wherein the relevancy score is used to select the one or more outlier user interests.

18. The non-transitory computer-readable medium of claim 16, wherein the relevancy score is generated using the following equation:
$${R}_{C} = \frac{{T}_{C}}{T} * ( {A}_{C} - 1 )$$
wherein
R_{C} is the relevancy score for a user interest C;
Tc is number of users in the target audience T with user interest C;
Tis the number of users in the target audience; and
Ac is the affinity score for user characteristic C.
